(19) United States
(12) Patent Application Publication
(10) Pub. No.: US 2007/0165930 A1
(43) Pub. Date: Jul. 19, 2007

(54) METHOD AND MEDICAL IMAGING APPARATUS FOR ADJUSTING OPERATING AND EVALUATION PARAMETERS OF THE APPARATUS

(76) Inventor: Ute Feuerlein, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 11/623,519

(22) Filed: Jan. 16, 2007

(30) Foreign Application Priority Data
Jan. 16, 2006 (DE) 10 2006 002 037.5

(51) Int. Cl. G06K 9/00

(52) U.S. Cl. 382/128

(57) ABSTRACT

In a method and medical imaging apparatus for adjustment of operating and evaluation parameters of the imaging apparatus, a scan protocol to be used for operation of the imaging apparatus is selected, the scan protocol being adapted to a volume to be examined, and, (dependent on the selection of the scan protocol, various parameter settings for the image generation are offered at a display. In each parameter setting both a convolution kernel and at least one window value for the image data processing are determined and the parameter settings are established via a single selection procedure.

### BACKGROUND OF THE INVENTION

1. Field of the Invention

The present invention concerns a method for adjustment of operating and evaluation parameters of an imaging apparatus for medical or other purposes, as well as a data processing system suitable for implementation of such a method.

2. Description of the Prior Art

A method for generation of images from computed tomography measurement data is known, for example, from DE 101 41 344 A1. In this method first image data of a first image with a first image property are initially calculated by convolution of the measurement data with a first convolution kernel that is designed for the generation of the first image property and subsequent back-projection. A filtering is subsequently provided with which second image data with a second image property are generated from the first image data.

A method for filtering tomographic 3D representations after a reconstruction of volume data is known from DE 10 2004 008 979 A1. In this method image values are filtered by a two-dimensional convolution.

### SUMMARY OF THE INVENTION

An object of the present invention is to provide a particularly user-friendly adjustment of operating and evaluation parameters of an imaging apparatus.

This object is achieved in accordance with the invention by a method for adjustment of operating and evaluation parameters of an imaging apparatus (in particular a computed tomography apparatus), wherein a scan protocol is selected for use in the operation of the apparatus that is matched (adapted) to the volume to be examined. The utilization of different measurement protocols for various examinations (scans) with an imaging diagnostic apparatus is known, for example, from U.S. Pat. No. 6,952,097 as well as from DE 10 2004 051 169 A1. In the case of an examination with an apparatus operating with x-ray radiation, in particular a tomography apparatus, a scan protocol includes (among other things) dose parameters. The scan protocol generally takes into account the type of the imaging installation. In particular a scan protocol can be selected from a number of predefined protocols and can be based on the positioning of the patient in a scanner, i.e. in the data acquisition unit of the imaging apparatus.

In a second step of the inventive method, various parameter settings of the imaging apparatus are automatically offered by the data processing system (dependent on the selection of the scan protocol made), with both a convolution kernel and at least one window value of the image data processing being determined in each parameter setting. The parameter settings can be established via a single selection procedure by the user, for example a single press of a button.

The convolution kernel is a reconstruction algorithm that generates an image that can be directly used for diagnostic purposes from the measurement data acquired with the imaging apparatus. In particular, sharpness, noise and edges in the generated image depend on the convolution kernel. Filtering of measurement data using a convolution kernel is also known as a filtered back-projection.

While the scan protocol concerns the operation of the apparatus, and thus establishes operating parameters, evaluation parameters are established by the kernel. Various convolution kernels are, among other things, adapted to the body region (in particular the organ) to be examined as well as to the type of the scanning (scan mode) set for the operation of the imaging apparatus, possibly also to the rotation time of the radiation source and/or the detector of the imaging apparatus. By means of the kernel it can likewise be taken into account whether an adult or a child is examined. In the examination of one and the same body region of a specific patient, different convolution kernels can be optimal depending on the purpose of the examination. For example, a first convolution kernel is primarily designed for the representation of soft tissues while a second convolution kernel is primarily suitable for representation of bones.

The selection of the window values automatically offered in the second step of the method simultaneously with the kernel selection pertains to the representation of grey values. For example, an image acquired with a typical imaging diagnostic apparatus exhibits 4096 different grey levels that can be divided into Hounsfield units (HE) and represent the tissue density. The scale of the grey values in computer tomography examinations typically ranges from −1024 HE to 3071 HE, whereby the value of 0 HE is associated with the density of water and the value of −1000 HE is associated with the lung density.

The number of the grey levels that the human eye can differentiate is significantly lower than the number of the grey values of the image acquired with the imaging apparatus. In order to be able to better differentiate different grey values of the image in a region that is particularly relevant for the diagnosis, the known method of windowing is used. DE 102 13 284 A1 as well as DE 197 34 725 A1 are referenced with regard to general features of this method. The observer has the possibility to place the window in that region that is diagnostically important. The middle (center) of the window is hereby typically placed at the average Hounsfield value of the structures of interest. The contrast can be controlled by means of the window width, with narrow windows producing particularly high-contrast. Conversely, in x-ray-technical examinations wide windows are selected in cases in which various tissues in a representation are to be made visible that effect a significantly different attenuation of the x-ray radiation, meaning in cases in which strong contrasts are present from the outset. This in particular applies to the lungs as well as to the skeleton.

The method for adjustment of operating and evaluation parameters of the medical imaging apparatus can be administered paticularly simply by the simultaneous selection of a convolution kernel and at least one window value of the image data processing. These parameters settings that are available are advantageously automatically displayed to the user in plain text, with each of these settings being explicitly designated by the tissue to be examined. At the point of a display of the designation of the tissue to be examined, or in addition thereto, it is also possible to display a corresponding graphical or symbolic representation (pictogram). In each case the user is given the ability to select one of multiple parameter settings via a single operator control action, the parameter settings differing both with regard to the convolution kernel and with regard to one or more window values (i.e. in particular the window center and/or the window width). In a first selection window the display of the parameter settings available for selection is advantageously limited to the plain text display of the tissue to be examined, possibly supplemented or replaced by a graphical representation. For clarity of the selection window, in this embodiment in particular no explicit (typically difficult to understand) designation of a convolution kernel is displayed, nor is a value of the window to be set in the image data processing displayed.

According to an embodiment, the convolution kernels stored with the various parameter settings as well as window values can be displayed as needed, advantageously in a second selection window. The user then has the possibility to adjust individual combinations of convolution kernels and window values that deviate from predetermined combinations of convolution kernels and window values. The user likewise has the possibility to store new combinations of convolution kernels and window settings as additional standard parameter settings.

In a preferred developments the data processing system offers the possibility to select various parameter settings such that the generation of various image data sets with different set parameters of the operation of the imaging apparatus and/or the evaluation of the raw data acquired with this imaging apparatus can be initiated simultaneously. For example, for an examination of the abdomen, three reconstructions of image data can be initiated simultaneously, namely a reconstruction of the soft tissue, a reconstruction of the lung and a bone reconstruction. A different parameter set that is adapted to the specific properties of the respective tissue is automatically used for each of these reconstructions. Even when the user modifies individual parameter settings for one or more reconstructions, the probably of incorrect settings is minimized since all other settings are automatically adopted from the stored standard settings.

An advantage of the invention is that, given the reconstruction of image data based on raw data acquired with a medical imaging apparatus, various combinations of respective convolution kernels with specific window values are stored as standard combinations and can be selected with a single input procedure, with a suitable selection of considered parameter settings being automatically displayed by a data processing system.

### DESCRIPTION OF THE DRAWINGS

FIG. 1 is a flowchart for an embodiment of a method for adjustment of operating and evaluation parameters of an imaging apparatus in accordance with the invention.

FIG. 2 is a schematic illustration of an embodiment of a medical imaging apparatus as well as a data processing system connected thereto, in accordance with the invention.

FIG. 3 is an example of a table showing possible parameter settings for an examination with a medical imaging-technical apparatus.

### DESCRIPTION OF THE PREFERRED EMBODIMENTS

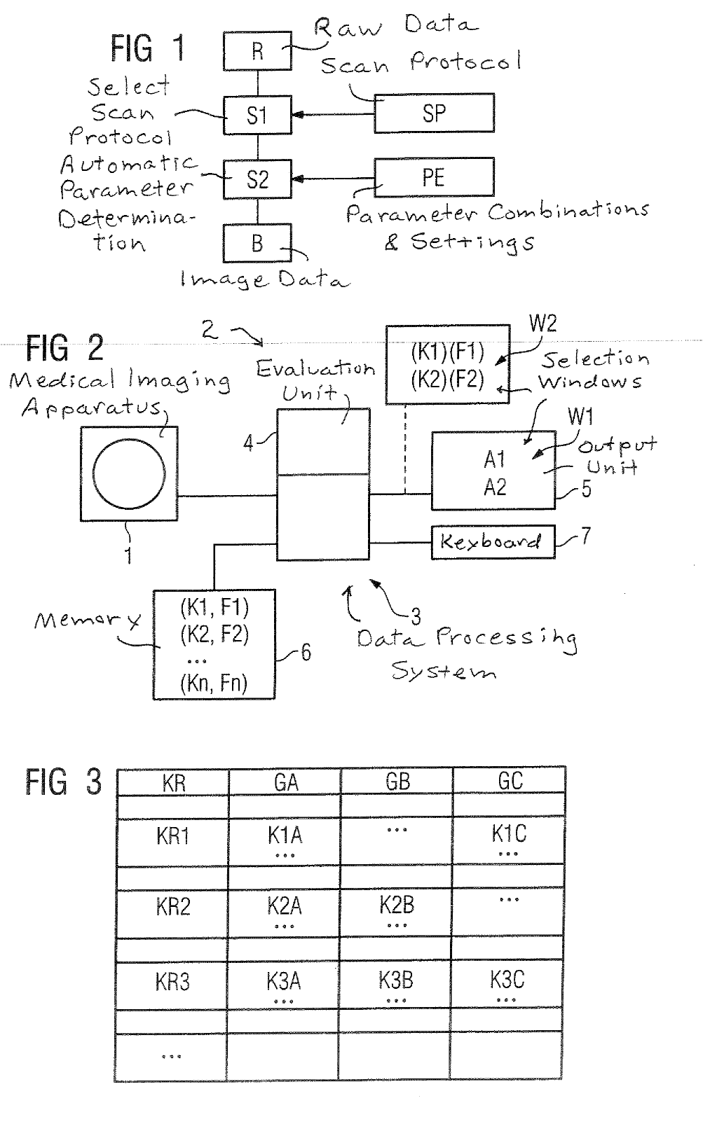

The method illustrated in FIGS. 1 and 2 start with raw data R that have been acquired by means of an imaging medical-technical apparatus 1, namely a computed tomography apparatus. The tissue of a patient (not shown) that is to be examined is scanned from various directions x-rays. This procedure is known as a scan; the parameters of the apparatus 1 that are thereby set are designated as scan parameters. The apparatus 1 is, for example, a type known as a whole-body scanner. The scan parameters to be set in the examination (for example dose parameters) are directly or indirectly embodied in a scan protocol SP.

In the computed tomography examination, an attenuation value is measured for each geometry (projection) of the x-rays, in particular for each exposure angle. By means of a mathematical transformation (namely a filtered back-projection known as a Radon transformation), a visible image is generated from the entirety of the attenuation values of the x-ray radiation acquired with the apparatus 1.

The subsequent explanations concern both FIG. 1, which schematically shows the workflow of the method that generates displayable image data B from the raw data R, and FIG. 2 which shows (in a roughly schematic manner) the device provided for implementation of the method.

In a first step S1 of the method a scan protocol SP (for example the scan protocol “lung”) is selected by the operator of the diagnosis system characterized overall with the reference character 2. The diagnosis system includes the medical imaging apparatus 1 as well as a data processing system 3.

In the next step S2 the data processing system 3 (including an evaluation unit 4 as well as a display device 5) automatically determines which parameter combinations or parameter settings PE are suitable for the evaluation of the raw data R. A parameter combination PE includes both a specific convolution seed and a specific setting of window values of the image data processing. The window values establish the window center, the window width and, if applicable, also parameters of a non-linear processing of grey values. The parameters concerning the convolution kernel are designated with K1, K2, . . . , Kn; the parameters concerning the window values are designated with F1, F2, . . . , Fn. Various parameter combinations (K1, F1), (K2, F2), . . . , (Kn, Fn) are stored in a memory 6 which is accessible by the evaluation unit 3 or is integrated therein.

A subset of the stored parameter combinations (K1, F1), (K2, F2), . . . ,(Kn, Fn) (which in combination is designated with PE for short) is automatically classified as suitable for the evaluation of the measured raw data R. In the present case the two parameter combinations are (K1, F1) and (K2, F2), but these are not directly displayed to the user. Instead, only a first selection text A1 as well as a second selection text A2 are displayed by the display device 5. In the data processing system 3 the first selection text A1 (namely “lung”) is stored with the parameter combination (K1, F1) and the second selection text A1 (namely “soft tissue”) is stored with the parameter combination (K2, F2). If one of these selection texts A1, A2 is selected by the user, the parameter settings PE for the representation of the lung parenchyma or of the soft tissue are activated by the data processing system 3 The user also has the possibility to select both parameter sets (K1, F1), (K2, F2). In this case the reconstruction of both selected representations can be initiated simultaneously.

The selection texts A1, A2 offered by the data processing system 3 and displayed on the screen as an output device 5 are designed in the manner of buttons that can be selected by the user, for example by means of a keyboard 7 or via a mouse click. In each case it is possible to establish both the convolution kernel K1, . . . , Kn and one or more window values F1, . . . , Fn of the image data processing via a single input action.

The selection texts A1, A2 are shown on the screen 5 in a first selection window W1, As needed the user can open a second selection window W2 that offers the possibility to separately set arbitrary parameters F1, . . . , Fn, K1, . . . , Kn. The second selection window W2 can be called, for example, by means of a mouse button or the keyboard 7.

Various possible settings of evaluation parameters that can be used for generation of image data B are summarized by section in FIG. 3. A body region to be examined with the imaging apparatus 1 is generally designated with KR. For example, the first body region KR1 means “head”, the second body region KR2 means “thorax” and the third body region KR3 means “abdomen”. The parameter settings in FIG. 3 exclusively concern the convolution seeds K1 through Kn. Three groups of different convolution seeds for the tissue types GA, GB, GC (namely soft tissue, lung and skeleton) are available. A number of scan protocols SP are associated with each body region KR in a manner not shown, with a number of possible convolution kernels K1, . . . , Kn as well as a number of possible window values F1, . . . , Fn existing for each of these scan protocols SP, and being stored in a databank (which is illustrated in FIG. 3).

Moreover, the databank in FIG. 3 also contains information as to which of the tissue types GA, GB, GC the parameter setting PE is to be adapted to with the greatest probability given the examination of a specific body region KR. The corresponding settings are designated as standard settings respectively associated with a body region KR as well as a scan protocol SP.

While convolution kernels K1A, K1C for the tissue types GA and GC (i.e. for soft tissues as well as for the skeleton) are typically available for examinations of the head (body region KR1), convolution kernels K2A, K2B for the tissue types GA and GB (thus for soft tissues as well as for the lung) are stored in the data processing system 3 for thorax examinations (body region KR2). Convolution kernels K3A, K3B, K3C for all cited tissue types GA, GB, GC are stored for the abdomen (body region KR3). In addition to the convolution kernels K1A, . . . , K3C entered as place holders into the table according to FIG. 3, further convolution kernels K1, . . . , Kn are stored that can be combined with different scan protocols SP, which convolution kernels K1, . . . , Kn, together with the window values F1, . . . , Fn, respectively form various selectable parameter settings PE.

Although modifications and changes may be suggested by those skilled in the art, it is the intention of the inventor to embody within the patent warranted hereon all changes and modifications as reasonably and properly come within the scope of the inventor's contribution to the art.

I claim as my invention:

1. A method for adjusting operating and evaluation parameters of a medical imaging apparatus, comprising the steps of:
selecting a scan protocol for operating a medical imaging apparatus to obtain raw data from a volume of an examination subject, said scan protocol being adapted to said volume; and
in a computer having a display, automatically determining and displaying, at said display, a plurality of parameter settings for use in generating an image of said volume from said raw data, each parameter setting representing a convolution kernel for transforming said raw data into image data and at least one window value for grey scale representation of said image data in said image, and allowing a user to interact with said display to select one of said plurality of parameter settings in a single selection procedure, and thereby automatically generate said image using the convolution kernel and the at least one window value represented by said one of said parameter settings.

2. A method as claimed in claim 1 comprising automatically displaying at said display, with each of said plurality of parameter settings, a plaintext description of the convolution kernel and the at least one window value represented thereby.

3. A method as claimed in claim 2 comprising displaying said plaintext descriptions and the respective parameter settings associated therewith in a selection window at said display used exclusively for selection of said one of said parameter settings.

4. A method as claimed in claim 3 wherein said selection window is a first selection window, and comprising allowing user interaction with said display to call and display a second selection window that allows user interaction therewith to modify the convolution kernel or the at least one window value of said one of said parameter settings selected via said first selection window.

5. A method as claimed in claim 1 comprising automatically displaying with each of said plurality of parameter settings at said display, a symbolic representation of tissue for which that parameter setting is suitable for image generation.

6. A method as claimed in claim 5 comprising displaying said symbolic representations and the respective parameter settings associated therewith in a selection window at said display used exclusively for selection of said one of said parameter settings.

7. A method as claimed in claim 6 wherein said selection window is a first selection window, and comprising allowing user interaction with said display to call and display a second selection window that allows user interaction therewith to modify the convolution kernel or the at least one window value of said one of said parameter settings selected via said first selection window.

8. A method as claimed in claim 1 comprising, at said display, automatically displaying, together with each of said parameter settings in said plurality of parameter settings, a plaintext description of the convolution kernel and the at least one window value represented thereby, and a symbolic representation of tissue for which image generation is suitable using that parameter setting.

9. A method as claimed in claim 8 comprising displaying said plaintext descriptions and said symbolic representations and the respective parameter settings associated therewith in a selection window at said display used exclusively for selection of said one of said parameter settings.

10. A method as claimed in claim 9 wherein said selection window is a first selection window, and comprising allowing user interaction with said display to call and display a second selection window that allows user interaction therewith to modify the convolution kernel or the at least one window value of said one of said parameter settings selected via said first selection window.

11. A method as claimed in claim 1 comprising offering, among said plurality of parameter settings at said display, a parameter setting for generating multiple sets of image data simultaneously with different convolution kernels and different window values.

12. A medical imaging apparatus allowing adjustment of operating and evaluation parameters thereof, comprising:
a data acquisition unit adapted to interact with a subject;
a control computer that operates said data acquisition unit;
a user interface connected to said control computer allowing a user to select a scan protocol for operating said acquisition unit to obtain raw data from a volume of the subject, said scan protocol being adapted to said volume; and
said user interface comprising a display, and said control computer automatically determining and displaying, at said display, a plurality of parameter settings for use in generating an image of said volume, each parameter setting representing a convolution kernel for transforming said raw data into image data and at least one window value for grayscale representation of said image data in said image, and said user interface allowing the user to interact with said display to select one of said plurality of parameter settings in a single selection procedure, and thereby cause said control computer to automatically generate said image using the convolution kernel and the at least one window value represented by said one of said parameter settings.

13. A medical imaging apparatus as claimed in claim 12 wherein said computer generates and displays respective parameter settings in said plurality of parameter settings that are respectively suitable for generating an image of different body regions, which differ both as to said convolution kernel and said at least one window value.

14. A data processing system for adjusting operating and evaluation parameters of a medical imaging apparatus having a control computer that operates said medical imaging apparatus to obtain raw data from a volume of an examination subject, said scan protocol being adapted to said volume, said data processing system comprising:
an image reconstruction computer;
a user interface connected to said image reconstruction computer and comprising a display; and
said image reconstruction computer automatically determining and displaying, at said display, a plurality of parameter settings for use in generating an image of said volume from said raw data, each parameter setting representing a convolution kernel for transforming said raw data into image data and at least one window value for grayscale representation of said image data in said image, and said user interface allowing a user to interact with said display to select one of said plurality of parameter settings in a single selection procedure, and thereby automatically causing said image reconstruction computer to generate said image using the convolution kernel and the at least one window value represented by said one of said parameter settings.

15. A data processing system as claimed in claim 14 wherein said image reconstruction computer automatically displaying at said display, with each of said plurality of parameter settings, a plaintext description of the convolution kernel and the at least one window value represented thereby.

16. A data processing system as claimed in claim 15 wherein said image reconstruction computer displays said plaintext descriptions and the respective parameter settings associated therewith in a selection window at said display used exclusively for selection of said one of said parameter settings.

17. A data processing system as claimed in claim 16 wherein said selection window is a first selection window, and wherein said user interface allows user interaction with said display to call and display a second selection window that allows user interaction therewith to modify the convolution kernel or the at least one window value of said one of said parameter settings selected via said first selection window.

18. A data processing system as claimed in claim 14 wherein said image reconstruction computer automatically displays with each of said plurality of parameter settings at said display, a symbolic representation of tissue for which that parameter setting is suitable for image generation.

19. A data processing system as claimed in claim 18 wherein said image reconstruction computer displays said symbolic representations and the respective parameter settings associated therewith in a selection window at said display used exclusively for selection of said one of said parameter settings.

20. A data processing system as claimed in claim 19 wherein said selection window is a first selection window, and wherein said user interface allows user interaction with said display to call and display a second selection window that allows user interaction therewith to modify the convolution kernel or the at least one window value of said one of said parameter settings selected via said first selection window.

21. A data processing system as claimed in claim 14 wherein said image reconstruction computer, at said display, automatically displays, together with each of said parameter settings in said plurality of parameter settings, a plaintext description of the convolution kernel and the at least one window value represented thereby, and a symbolic representation of tissue for which image generation is suitable using that parameter setting.

22. A data processing system as claimed in claim 21 wherein said image reconstruction computer displays said plaintext descriptions and said symbolic representations and the respective parameter settings associated therewith in a selection window at said display used exclusively for selection of said one of said parameter settings.

23. A data processing system as claimed in claim 22 wherein said selection window is a first selection window, and wherein said user interface allows user interaction with said display to call and display a second selection window that allows user interaction therewith to modify the convolution kernel or the at least one window value of said one of said parameter settings selected via said first selection window.

24. A data processing system as claimed in claim 14 wherein said image reconstruction computer offers, among said plurality of parameter settings at said display, a parameter setting for generating multiple sets of image data simultaneously with different convolution kernels and different window values.

25. A data processing system as claimed in claim 14 comprising a single computer comprising said control computer and said image reconstruction computer.
